(19) United States
(12) Patent Application Publication
(10) Pub. No.: US 2017/0171603 A1
(43) Pub. Date: Jun. 15, 2017

(54) Method, electronic device and system for playing multiple channels of video data

(71) Applicants: Le Holdings (Beijing) Co., Ltd., Beijing (CN); LETV SPORTS CULTURE DEVELOP(BEIJING) CO., LTD., Beijing (CN)

(72) Inventors: Pengfei Zheng, Beijing (CN); Yu Liu, Beijing (CN); Jie Shen, Beijing (CN)

(21) Appl. No.: 15/246,399

(22) Filed: Aug. 24, 2016

Related U.S. Application Data
(63) Continuation of application No. PCT/CN2016/089481, filed on Jul. 8, 2016.

(30) Foreign Application Priority Data
Dec. 10, 2015 (CN) 201510918985.0

(51) Int. Cl. H04N 21/431; H04N 21/234; H04N 21/434; H04N 21/472; H04N 21/44; H04L 29/06; H04N 21/2365

(52) U.S. Cl. CPC H04N 21/4312; H04L 67/42; H04N 21/234; H04N 21/2365; H04L 65/60; H04N 21/472; H04N 21/44; H04N 21/4347

(57) ABSTRACT

Disclosed are a method, an electronic device and a system for playing multiple channels of video data. The method includes: obtaining a play request for playing multiple channels of video data from a client, wherein identification information of a terminal device and identification information corresponding to the multiple channels of video data are carried in the play request; according to the identification information of the terminal device, determining the number of video layers corresponding to the terminal device; if it is determined that the number of the multiple channels of video data is greater than the number of video layers, according to the identification information corresponding to the multiple channels of video data, obtaining the same number of channels of video data as the number of video layers and picture data corresponding to remaining channels of video data, and sending the obtained data to the client. The picture data is picture representation of corresponding video data. Thus, the client can play the channels of video data and the picture data corresponding to remaining channels of video data simultaneously using a multi-channel player.

### CROSS REFERENCE TO RELATED APPLICATIONS

This application is a continuation of International Application No. PCT/CN2016/089481, filed on Jul. 8, 2016, which is based upon and claims priority to Chinese Patent Application No. 201510918985.0, filed on Dec. 10, 2015, the entire contents of all of which are incorporated herein by reference.

### TECHNICAL FIELD

The present disclosure relates to information technologies, and more particularly, to a method, an electronic device and a system for playing multiple channels of video data.

### BACKGROUND

With constant developments of Internet technologies, playing of video has become an important technology in the Internet field. Existing video playing methods can include playing video with a small window, or playing video in full screen. In actual video playing, for example, playing of sport events, in order to meet users' viewing requirements, multiple channels of video data needs to be displayed on the same screen. Thus, many terminal devices use optimized hardware, for example, a plurality of video layers, to support the playing of multi-channel video data. Each video layer includes a processor, an encoder, a display chip, and the like.

At present, the multi-channel video data requested by users are played depending on the number of video layers provided in terminal devices. In other words, the number of the multiple channels of video data requested by users needs to be smaller than or equal to the number of video layers provided in terminal devices. However, using such method, if the number of the channels of the video data requested by users is greater than the number of video layers provided by terminal devices, the channels of video data in excess of the number of video layers provided in terminal devices cannot be played on the screen, and thus the multiple channels of video data requested by users cannot be played simultaneously on the same screen. As a result, accuracy in video playing is relatively low.

### SUMMARY

The present disclosure provides a method, an electronic device and a system for playing multiple channels of video data so as to solve the problem of relatively low accuracy in video playing.

In a first aspect, embodiments of the present disclosure provide a method for playing multiple channels of video data, implemented by a server, including:

obtaining a play request for playing multiple channels of video data from a client, wherein identification information of a terminal device and identification information corresponding to the multiple channels of video data are carried in the play request;

according to the identification information of the terminal device, determining the number of video layers corresponding to the terminal device;

determining whether the number of the multiple channels of video data is greater than the number of video layers;

if the number of the multiple channels of video data is greater than the number of video layers, obtaining first video data according to the identification information corresponding to the multiple channels of video data, wherein the first video data includes the same number of channels of video data as the number of video layers, and picture data corresponding to remaining channels of video data, and the picture data is picture representation of corresponding video data;

sending the first video data to the client, so that the client plays the channels of video data and the picture data corresponding to remaining channels of video data simultaneously using a multi-channel player.

In a second aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for playing multiple channels of video data mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to :

send a play request for playing multiple channels of video data to a server, wherein identification information of a terminal device and identification information corresponding to the multiple channels of video data are carried in the play request;

receive first video data sent from the server, wherein the first video data comprises the same number of channels of video data as the number of video layers corresponding to the terminal device, and picture data corresponding to remaining channels of video data, wherein the number of video layers corresponding to the terminal device is determined according to the identification information of the terminal device, the picture data is picture representation of corresponding video data, and the first video data is sent from the server when the number of the multiple channels of video data is greater than the number of video layers; and

play the video data and the picture data simultaneously using a multi-channel player.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for playing multiple channels of video data in accordance with some embodiments;

FIG. 2 is a flow chart of another method for playing multiple channels of video data in accordance with some embodiments;

FIG. 3 is a flow chart of another method for playing multiple channels of video data in accordance with some embodiments;

FIG. 4 is a flow chart of another method for playing multiple channels of video data in accordance with some embodiments;

FIG. 5 is a block diagram showing a server in accordance with some embodiments;

FIG. 6 is a block diagram showing another server in accordance with some embodiments;

FIG. 7 is a block diagram showing a client in accordance with some embodiments;

FIG. 8 is a block diagram showing another client in accordance with some embodiments;

FIG. 9 is a block diagram showing a system for playing multiple channels of video data in accordance with some embodiments;

FIG. 10 is a schematic diagram showing a physical server in accordance with some embodiments; and

FIG. 11 is a block diagram of an electronic device which is configured to perform the methods for playing multiple channels of video data in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

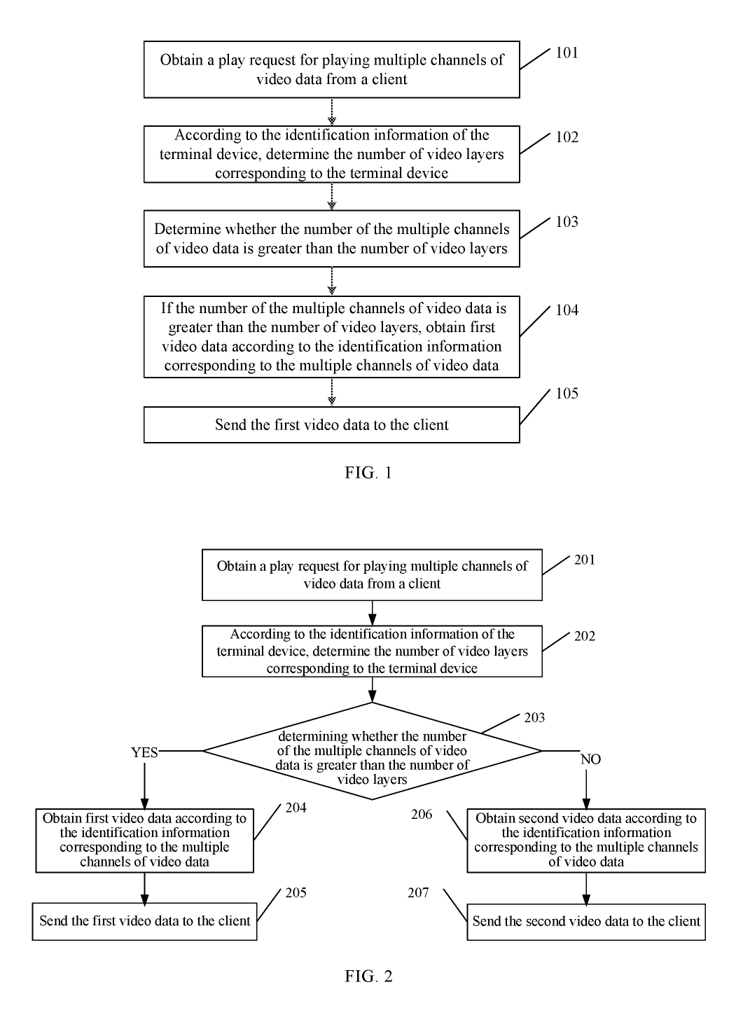

Embodiments of the present disclosure provide a method for playing multiple channels of video data, which can be applied in a server. As shown in FIG. 1, the method can include the following steps.

In 101, a play request for playing multiple channels of video data is obtained from a client.

Identification information of a terminal device and identification information corresponding to the multiple channels of video data can be carried in the play request. For example, the terminal device can be a TV, a mobile phone, a computer, a tablet, and the like. However, embodiments of the present disclosure are not limited to this. The identification information of the terminal device may be the name of the terminal device, or may be the identity (ID) of the terminal device, and embodiments of the present disclosure do not impose limitations on this. The identification information of the video data can be the name of the video data, or the ID of the video data, and embodiments of the present disclosure do not impose limitations on this.

It should be noted that the video data can be video streaming data. The server sends the video data to a client. Then, the client decodes the video data, and plays the decoded video data. Decoding and playing of the video data need supports by hardware devices in the terminal device, for example, decoders and video cards and the like.

In 102, according to the identification information of the terminal device, the number of video layers corresponding to the terminal device is determined.

The server can store the identification information of the terminal device and the number of video layers corresponding to the terminal device. Thus, according to the identification information of the terminal device, the number of video layers corresponding to the terminal device can be inquired. The video layers can be hardware devices in the terminal device, and each of the video layers can include a processor, a decoder, a display chip, and the like.

For example, a mobile phone or a computer usually have only one video layer, and some TV provides may provide two or three video layers for their TVs.

In 103, whether the number of the multiple channels of video data is greater than the number of video layers is determined.

For example, if there are four channels of video data and the terminal device can support two video layers, it can be seen that the number of the channels of video data is greater than the number of the video layers.

In 104, if the number of the multiple channels of video data is greater than the number of video layers, first video data is obtained according to the identification information corresponding to the multiple channels of video data.

The first video data includes the same number of channels of video data as the number of video layers, and picture data corresponding to remaining channels of video data, and the picture data is picture representation of corresponding video data. Specifically, the picture data can be video frames or combination of video frames in the video data, and the combination of video frames can be in the form of slides.

In embodiments of the present disclosure, the server can generate picture data in advance according to the video data, and when the number of the multiple channels of video data requested by a user is greater than the number of video layers, send the picture data corresponding to the channels of video data in excess of the number of video layers to the client. This can overcome the limitations of the hardware devices in the terminal device, and thus the client can play the multiple channels of video data requested by the user.

In 105, the first video data is sent to the client.

In this way, the client can play the channels of video data and the picture data corresponding to remaining channels of video data simultaneously using a multi-channel player.

In embodiments of the present disclosure, the client can provide a multi-channel player on a page in a multi-instance mode. After the client receives individual channels of video data, the player can decode and play the individual channels of video data. Since there is no limitation on displaying of picture data in the hardware devices of the terminal device, the client can directly play and display received picture data.

In the method for playing multiple channels of video data provided by embodiments of the present disclosure, when the number of multiple channels of video data requested by a client is greater than the number of video layers provided in a terminal device, the same number of channels of video data as the number of video layers and picture data corresponding to remaining channels of video data are sent to the client. The method of the present disclosure can overcome the defect in conventional technologies that the channels of video data in excess of the number of video layers cannot be played on the screen. Thus, the accuracy in video playing can be increased.

Embodiments of the present disclosure provide another method for playing multiple channels of video data, which can be applied in a server. As shown in FIG. 2, the method can include the following steps.

In 201, a play request for playing multiple channels of video data is obtained from a client.

In 202, according to the identification information of the terminal device, the number of video layers corresponding to the terminal device is determined.

In the embodiment, before step 202, the following steps can be included: obtaining the identification information of the terminal device and the number of video layers corresponding to the terminal device; and storing the identification information of the terminal device and the number of video layers. Under such condition, step 202 can include: inquiring the number of video layers corresponding to the terminal device according to the identification information of the terminal device.

The identification information of the terminal device and the number of video layers can be stored by the server in the form of a preset storage table or a preset database, and however the present disclosure is not limited to this. If the identification information of the terminal device and the number of video layers are stored in the form of a preset storage table, an example of the table can be found in Table 1.

TABLE 1

| Identification information of terminal devices | Number of video layers |
|---|---|
| TV-1 | 3 |
| Phone-1 | 1 |
| PC-1 | 1 |

In embodiments of the present disclosure, before storing of the identification information of the terminal device and the number of the video layers, the method can further include: determining whether there is an update of the number of video layers corresponding to the terminal device. The storing of the identification information of the terminal device and the number of video layers can include: if there is an update of the number of video layers corresponding to the terminal device, storing the identification information of the terminal device and the updated number of video layers.

As the hardware technologies are improved, providers of terminal devices may update the number of video layers supported by the terminal devices. By storing the updated number of video layers, the play effect of the multi-channel video data can be guaranteed, thereby improving users' experience.

In 203, whether the number of the multiple channels of video data is greater than the number of video layers is determined. If the number of the multiple channels of video data is greater than the number of video layers, step 204 is performed; if the number of the multiple channels of video data is smaller than or equal to the number of video layers, step 206 is performed.

In 204, first video data is obtained according to the identification information corresponding to the multiple channels of video data.

The first video data includes the same number of channels of video data as the number of video layers, and picture data corresponding to remaining channels of video data, and the picture data is picture representation of corresponding video data.

In embodiment of the present disclosure, before step 204, the following steps can be included: obtaining video data; generating the picture data according to the video data; and storing the video data and the picture data.

In 205, the first video data is sent to the client.

In this way, the client can play the channels of video data and the picture data corresponding to remaining channels of video data simultaneously using a multi-channel player.

In 206, second video data is obtained according to the identification information corresponding to the multiple channels of video data.

The second video data is the requested multiple channels of video data.

In 207, the second video data is sent to the client.

In this way, client can play the multiple channels of video data simultaneously using the multi-channel player.

In the method for playing multiple channels of video data provided by embodiments of the present disclosure, when the number of multiple channels of video data requested by a client is greater than the number of video layers provided in a terminal device, the same number of channels of video data as the number of video layers and picture data corresponding to remaining channels of video data are sent to the client. The method of the present disclosure can overcome the defect in conventional technologies that the channels of video data in excess of the number of video layers cannot be played on the screen. Thus, the accuracy in video playing can be increased.

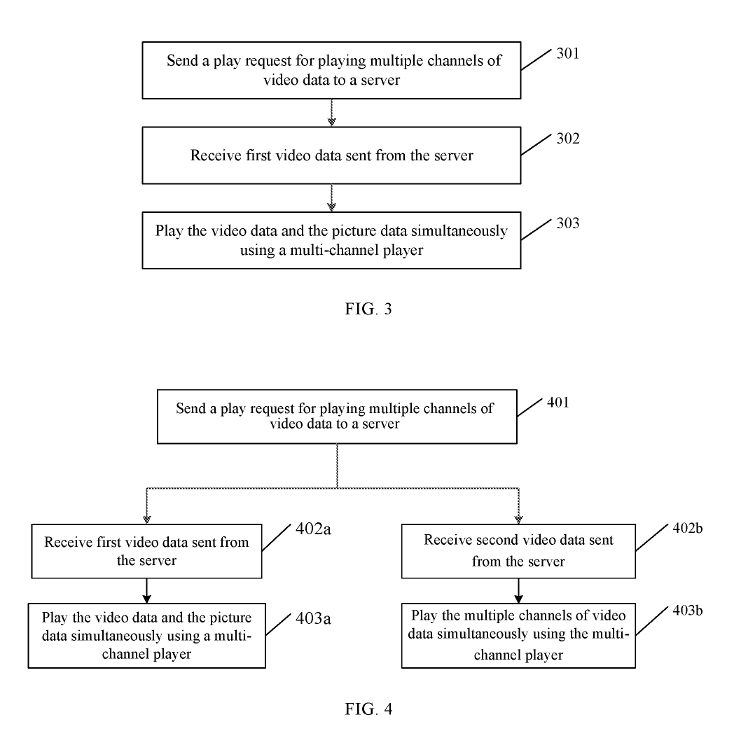

Embodiments of the present disclosure provide another method for playing multiple channels of video data, which can be applied in a client. As shown in FIG. 3, the method can include the following steps.

In 301, a play request for playing multiple channels of video data is sent to a server.

Identification information of a terminal device and identification information corresponding to the multiple channels of video data can be carried in the play request.

In 302, first video data sent from the server is received.

The first video data includes the same number of channels of video data as the number of video layers corresponding to the terminal device, and picture data corresponding to remaining channels of video data. The number of video layers corresponding to the terminal device is determined according to the identification information of the terminal device. The picture data is picture representation of corresponding video data. The first video data is sent from the server when the number of the multiple channels of video data is greater than the number of video layers.

In 303, the video data and the picture data are played simultaneously using a multi-channel player.

In the method for playing multiple channels of video data provided by embodiments of the present disclosure, when the number of multiple channels of video data requested by a client is greater than the number of video layers provided in a terminal device, the same number of channels of video data as the number of video layers and picture data corresponding to remaining channels of video data are sent to the client. The method of the present disclosure can overcome the defect in conventional technologies that the channels of video data in excess of the number of video layers cannot be played on the screen. Thus, the accuracy in video playing can be increased.

Embodiments of the present disclosure provide another method for playing multiple channels of video data, which can be applied in a client. As shown in FIG. 4, the method can include the following steps.

In 401, a play request for playing multiple channels of video data is sent to a server.

Identification information of a terminal device and identification information corresponding to the multiple channels of video data can be carried in the play request.

In 402a, first video data sent from the server is received.

The first video data includes the same number of channels of video data as the number of video layers corresponding to the terminal device, and picture data corresponding to remaining channels of video data. The number of video layers corresponding to the terminal device is determined according to the identification information of the terminal device. The picture data is picture representation of corresponding video data. The first video data is sent from the server when the number of the multiple channels of video data is greater than the number of video layers.

In 403a, the video data and the picture data are played simultaneously using a multi-channel player.

In the embodiment of the present disclosure, step 403a can specifically include: playing the video data and the picture data on different portions of the same screen.

In step 402b, which is in parallel with step 402a, second video data sent from the server is received.

The second video data is the requested multiple channels of video data, and the second video data is sent from the server when the number of the multiple channels of video data is smaller than or equal to the number of video layers.

In 403b, the multiple channels of video data are played simultaneously played using the multi-channel player.

In the method for playing multiple channels of video data provided by embodiments of the present disclosure, when the number of multiple channels of video data requested by a client is greater than the number of video layers provided in a terminal device, the same number of channels of video data as the number of video layers and picture data corresponding to remaining channels of video data are sent to the client. The method of the present disclosure can overcome the defect in conventional technologies that the channels of video data in excess of the number of video layers cannot be played on the screen. Thus, the accuracy in video playing can be increased.

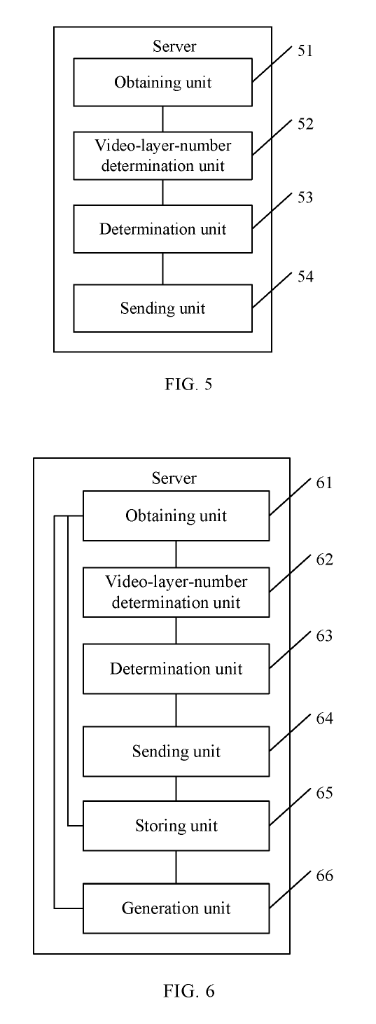

Further, embodiments of the present disclosure provide a server to implement the method described in connection with FIG. 1. As shown in FIG. 5, the server can include an obtaining unit 51, a video-layer-number determination unit 52, a determination unit 53 and a sending unit 54.

The obtaining unit 51 is configured to obtain a play request for playing multiple channels of video data from a client. Identification information of a terminal device and identification information corresponding to the multiple channels of video data can be carried in the play request. The identification information of the terminal device may be the name of the terminal device, or may be the identity (ID) of the terminal device, and embodiments of the present disclosure do not impose limitations on this. The identification information of the video data can be the name of the video data, or the ID of the video data, and embodiments of the present disclosure do not impose limitations on this. The obtaining unit 51 is a main functional module in the server for obtaining the play request for playing multiple channels of video data from the client.

The video-layer-number determination unit 52 is configured to, according to the identification information of the terminal device, determine the number of video layers corresponding to the terminal device. The video-layer-number determination unit 52 is a main functional module in the server for determining the number of video layers corresponding to the terminal device.

The determination unit 53 is configured to determine whether the number of the multiple channels of video data is greater than the number of video layers. The determination unit 53 is a main functional module in the server for determining whether the number of the multiple channels of video data is greater than the number of video layers.

The obtaining unit 51 is further configured to, if the number of the multiple channels of video data is greater than the number of video layers, obtain first video data according to the identification information corresponding to the multiple channels of video data. The first video data includes the same number of channels of video data as the number of video layers, and picture data corresponding to remaining channels of video data, and the picture data is picture representation of corresponding video data. Specifically, the picture data can be video frames or combination of video frames in the video data, and the combination of video frames can be in the form of slides. The obtaining unit 51 is a main functional module in the server for obtaining first video data.

The sending unit 54 is configured to send the first video data to the client, so that the client plays the channels of video data and the picture data corresponding to remaining channels of video data simultaneously using a multi-channel player. The client can provide a multi-channel player on a page in a multi-instance mode. The sending unit 54 is a main functional module in the server for sending the first video data to the client.

It should be noted that descriptions regarding the method in FIG. 1 also apply to respective units in the server provided by embodiments of the present disclosure, and thus repeated descriptions will be omitted here. In embodiments of the present disclosure, a hardware processor can be used to realize the functions of respective units or modules in the server.

In the client provided by embodiments of the present disclosure, when the number of multiple channels of video data requested by a client is greater than the number of video layers provided in a terminal device, the same number of channels of video data as the number of video layers and picture data corresponding to remaining channels of video data are sent to the client. The server of the present disclosure can overcome the defect in conventional technologies that the channels of video data in excess of the number of video layers cannot be played on the screen. Thus, the accuracy in video playing can be increased.

Further, embodiments of the present disclosure provide another server to implement the method described in connection with FIG. 2. As shown in FIG. 6, the server can include an obtaining unit 61, a video-layer-number determination unit 62, a determination unit 63 and a sending unit 64.

The obtaining unit 61 is configured to obtain a play request for playing multiple channels of video data from a client. Identification information of a terminal device and identification information corresponding to the multiple channels of video data can be carried in the play request. The obtaining unit 61 is a main functional module in the server for obtaining the play request for playing multiple channels of video data from the client.

The video-layer-number determination unit 62 is configured to, according to the identification information of the terminal device, determine the number of video layers corresponding to the terminal device. The video-layer-number determination unit 62 is a main functional module in the server for determining the number of video layers corresponding to the terminal device.

The determination unit 63 is configured to determine whether the number of the multiple channels of video data is greater than the number of video layers. The determination unit 63 is a main functional module in the server for determining whether the number of the multiple channels of video data is greater than the number of video layers.

The obtaining unit 61 is further configured to, if the number of the multiple channels of video data is greater than the number of video layers, obtain first video data according to the identification information corresponding to the multiple channels of video data. The first video data includes the same number of channels of video data as the number of video layers, and picture data corresponding to remaining channels of video data, and the picture data is picture representation of corresponding video data. The obtaining unit 61 is a main functional module in the server for obtaining the first video data.

The sending unit 64 is configured to send the first video data to the client, so that the client plays the channels of video data and the picture data corresponding to remaining channels of video data simultaneously using a multi-channel player.

The server further includes a storing unit 65.

The obtaining unit 62 is further configured to obtain the identification information of the terminal device and the number of video layers corresponding to the terminal device.

The storing unit 65 is configured to store the identification information of the terminal device and the number of video layers.

The video-layer-number determination unit 62 is configured to inquire the number of video layers corresponding to the terminal device according to the identification information of the terminal device.

The determination unit 63 is configured to determine whether there is an update of the number of video layers corresponding to the terminal device.

The storing unit 65 is configured to store the identification information of the terminal device and the updated number of video layers if it is determined that there is an update of the number of video layers corresponding to the terminal device.

The server further includes a generation unit 66.

The obtaining unit 61 is further configured to obtain video data.

The generation unit 66 is configured to generate the picture according to the video data.

The storing unit 65 is configured to store the video data and the picture data.

The obtaining unit 61 is further configured to obtain second video data according to the identification information corresponding to the multiple channels of video data if the number of the multiple channels of video data is smaller than or equal to the number of video layers. The second video data is the requested multiple channels of video data.

It should be noted that descriptions regarding the method in FIG. 2 also apply to respective units in the server provided by embodiments of the present disclosure, and thus repeated descriptions will be omitted here. In embodiments of the present disclosure, a hardware processor can be used to realize the functions of respective units or modules in the server.

In the server provided by embodiments of the present disclosure, when the number of multiple channels of video data requested by a client is greater than the number of video layers provided in a terminal device, the same number of channels of video data as the number of video layers and picture data corresponding to remaining channels of video data are sent to the client. The server of the present disclosure can overcome the defect in conventional technologies that the channels of video data in excess of the number of video layers cannot be played on the screen. Thus, the accuracy in video playing can be increased.

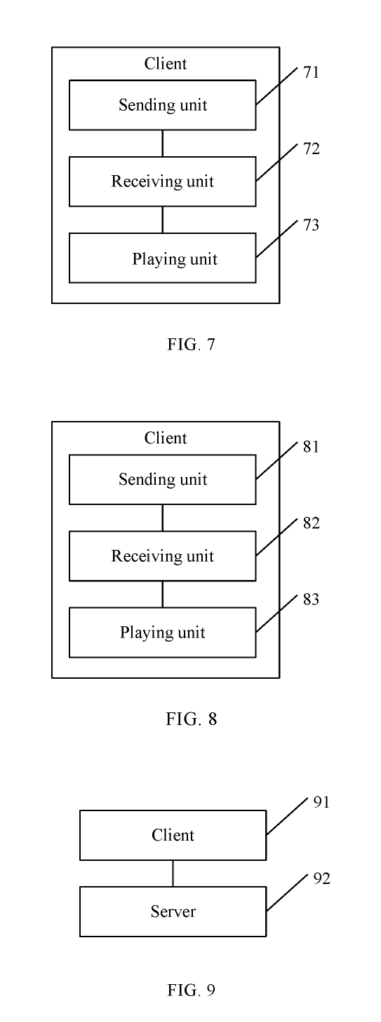

Further, embodiments of the present disclosure provide a client to implement the method described in connection with FIG. 3. As shown in FIG. 7, the client can include a sending unit 71, a receiving unit 72, and a playing unit 73.

The sending unit 71 is configured to send a play request for playing multiple channels of video data to a server. Identification information of a terminal device and identification information corresponding to the multiple channels of video data can be carried in the play request. The sending unit 71 is a main functional module in the client for sending the play request for playing multiple channels of video data to the server.

The receiving unit 72 is configured to receive first video data sent from the server. The first video data includes the same number of channels of video data as the number of video layers corresponding to the terminal device, and picture data corresponding to remaining channels of video data. The number of video layers corresponding to the terminal device is determined according to the identification information of the terminal device. The picture data is picture representation of corresponding video data. The first video data is sent from the server when the number of the multiple channels of video data is greater than the number of video layers. The receiving unit 72 is a main functional module in the client for receiving the first video data sent from the server.

The playing unit 73 is configured to play the video data and the picture data simultaneously using a multi-channel player. The playing unit 73 is a main functional module in the client for playing the video data and the picture data simultaneously using the multi-channel player.

It should be noted that descriptions regarding the method in FIG. 3 also apply to respective units in the client provided by embodiments of the present disclosure, and thus repeated descriptions will be omitted here. In embodiments of the present disclosure, a hardware processor can be used to realize the functions of respective units or modules in the client.

In the client provided by embodiments of the present disclosure, when the number of multiple channels of video data requested by the client is greater than the number of video layers provided in a terminal device, the same number of channels of video data as the number of video layers and picture data corresponding to remaining channels of video data are sent to the client. The client of the present disclosure can overcome the defect in conventional technologies that the channels of video data in excess of the number of video layers cannot be played on the screen. Thus, the accuracy in video playing can be increased.

Further, embodiments of the present disclosure further provide a client to implement the method described in connection with FIG. 4. As shown in FIG. 8, the client can include a sending unit 81, a receiving unit 82, and a playing unit 83.

The sending unit 81 is configured to send a play request for playing multiple channels of video data to a server. Identification information of a terminal device and identification information corresponding to the multiple channels of video data can be carried in the play request. The sending unit 81 is a main functional module in the client for sending the play request for playing multiple channels of video data to the server.

The receiving unit 82 is configured to receive first video data sent from the server. The first video data includes the same number of channels of video data as the number of video layers corresponding to the terminal device, and picture data corresponding to remaining channels of video data. The number of video layers corresponding to the terminal device is determined according to the identification information of the terminal device. The picture data is picture representation of corresponding video data. The first video data is sent from the server when the number of the multiple channels of video data is greater than the number of video layers. The receiving unit 82 is a main functional module in the client for receiving the first video data sent from the server.

The playing unit 83 is configured to play the video data and the picture data simultaneously using a multi-channel player.

The receiving unit 82 is further configured to receive second video data. The second video data is the requested multiple channels of video data, and the second video data is sent from the server when the number of the multiple channels of video data is smaller than or equal to the number of video layers.

Specifically, the playing unit is configured to play the multiple channels of video data simultaneously using the multi-channel player. The playing unit 83 is a main functional module in the client for playing the video data and the picture data simultaneously using the multi-channel player.

Specifically, the playing unit 83 is configured to play the video data and the picture data on different portions of the same screen.

It should be noted that descriptions regarding the method in FIG. 4 also apply to respective units in the client provided by embodiments of the present disclosure, and thus repeated descriptions will be omitted here. In embodiments of the present disclosure, a hardware processor can be used to realize the functions of respective units or modules in the client.

In the client provided by embodiments of the present disclosure, when the number of multiple channels of video data requested by the client is greater than the number of video layers provided in a terminal device, the same number of channels of video data as the number of video layers and picture data corresponding to remaining channels of video data are sent to the client. The client of the present disclosure can overcome the defect in conventional technologies that the channels of video data in excess of the number of video layers cannot be played on the screen. Thus, the accuracy in video playing can be increased.

Embodiments of the present disclosure provide a system for playing multiple channels of video data. As shown in FIG. 9, the system can include a client 91 and a server 92.

The client 91 is configured to send a play request for playing multiple channels of video data to the server 92. Identification information of a terminal device and identification information corresponding to the multiple channels of video data can be carried in the play request.

The server 92 is configured to: according to the identification information of the terminal device, determine the number of video layers corresponding to the terminal device; determine whether the number of the multiple channels of video data is greater than the number of video layers; if the number of the multiple channels of video data is greater than the number of video layers, obtain first video data according to the identification information corresponding to the multiple channels of video data, wherein the first video data includes the same number of channels of video data as the number of video layers, and picture data corresponding to remaining channels of video data, and the picture data is picture representation of corresponding video data; and send the first video data to the client 91.

The client is further configured to play the video data and the picture data simultaneously using a multi-channel player.

It should be noted that the functions of respective units or modules in the above clients, servers and system for playing multiple channels of video data according to embodiments of the present disclosure can be realized by hardware processors.

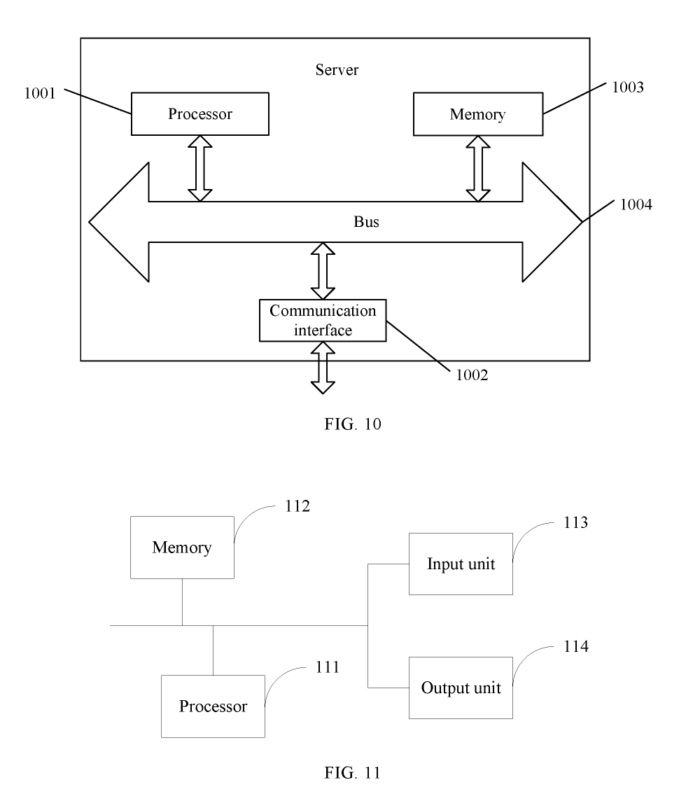

As an example, FIG. 10 is a block diagram showing a physical structure of a server in accordance with an embodiment of the present disclosure. The server can include a processor 1001, a communication interface 1002, a memory 1003 and a bus 1004. The processor 1001, the communication interface 1002 and the memory 1003 communicate with each other via the bus 1004. The communication interface 1002 may be used for information transmission between the server and a client. The processor 1001 calls logic instructions in the memory 1003 to perform the following method: obtaining a play request for playing multiple channels of video data from a client, wherein identification information of a terminal device and identification information corresponding to the multiple channels of video data are carried in the play request; according to the identification information of the terminal device, determining the number of video layers corresponding to the terminal device; determining whether the number of the multiple channels of video data is greater than the number of video layers; if the number of the multiple channels of video data is greater than the number of video layers, obtaining first video data according to the identification information corresponding to the multiple channels of video data, wherein the first video data includes the same number of channels of video data as the number of video layers, and picture data corresponding to remaining channels of video data, and the picture data is picture representation of corresponding video data; and sending the first video data to the client, so that the client plays the channels of video data and the picture data corresponding to remaining channels of video data simultaneously using a multi-channel player.

In addition, the logic instructions in the memory 1003 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

In the system for playing multiple channels of video data provided by embodiments of the present disclosure, when the number of multiple channels of video data requested by the client is greater than the number of video layers provided in a terminal device, the same number of channels of video data as the number of video layers and picture data corresponding to remaining channels of video data are sent to the client. The client of the present disclosure can overcome the defect in conventional technologies that the channels of video data in excess of the number of video layers cannot be played on the screen. Thus, the accuracy in video playing can be increased.

Further, an embodiment of the present disclosure further provides a non-transitory computer-readable storage medium storing executable instructions, which can be executed by an electronic device to perform any methods for playing multiple channels of video data mentioned by embodiments of the present disclosure.

FIG. 11 is a block diagram of an electronic device which is configured to perform the methods for playing multiple channels of video data according to an embodiment of the present disclosure. As shown in FIG. 11, the device includes:

one or more processors 111 and memory 112. A processor 111 is showed in FIG. 11 for an example.

Device which is configured to perform the methods for playing multiple channels of video data can also include: input unit 113 and output unit 114.

Processor 111, memory 112, input unit 113 and output unit 114 can be connected by BUS or other methods, and BUS connecting is showed in FIG. 11 for an example.

Memory 112 can be used for storing non-transitory software program, non-transitory computer executable program and modules as a non-transitory computer-readable storage medium, such as corresponding program instructions/modules for the methods for playing multiple channels of video data mentioned by embodiments of the present disclosure (such as shown in FIG. 5, obtaining unit 51, video-layer-number determination unit 52, determination unit 53 and sending unit 54). Processor 111 performs kinds of functions and playing multiple channels of video data of the electronic device by executing non-transitory software program, instructions and modules which are stored in memory 112, thereby realizes the methods for playing multiple channels of video data mentioned by embodiments of the present disclosure.

Memory 112 can include program storage area and data storage area, thereby the operating system and applications required by at least one function can be stored in program storage area and data created by using the device for playing multiple channels of video data can be stored in data storage area. Furthermore, memory 112 can include high speed Random-access memory (RAM) or non-volatile memory such as magnetic disk storage device, flash memory device or other non-volatile solid state storage devices. In some embodiments, memory 112 can include long-distance setup memories relative to processor 111, which can communicate with the device for playing multiple channels of video data by networks. The examples of said networks are including but not limited to Internet, Intranet, LAN, mobile Internet and their combinations.

Input unit 113 can be used to receive inputted number, character information and key signals causing user configures and function controls of the device for playing multiple channels of video data. Output unit 114 can include a display screen or a display device.

The said module or modules are stored in memory 112 and perform the methods for playing multiple channels of video data when executed by one or more processors 111.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for playing multiple channels of video data, implemented by a server, comprising:
obtaining a play request for playing multiple channels of video data from a client, wherein identification information of a terminal device and identification information corresponding to the multiple channels of video data are carried in the play request;
according to the identification information of the terminal device, determining the number of video layers corresponding to the terminal device;
determining whether the number of the multiple channels of video data is greater than the number of video layers;
if the number of the multiple channels of video data is greater than the number of video layers, obtaining first video data according to the identification information corresponding to the multiple channels of video data, wherein the first video data comprises the same number of channels of video data as the number of video layers, and picture data corresponding to remaining channels of video data, and the picture data is picture representation of corresponding video data; and
sending the first video data to the client, so that the client plays the channels of video data and the picture data corresponding to remaining channels of video data simultaneously using a multi-channel player.

2. The method according to claim 1, wherein before determining of the number of video layers corresponding to the terminal device according to the identification information of the terminal device, the method further comprises:
obtaining the identification information of the terminal device and the number of video layers corresponding to the terminal device; and
storing the identification information of the terminal device and the number of video layers;
wherein the determining of the number of video layers corresponding to the terminal device according to the identification information of the terminal device comprises:
inquiring the number of video layers corresponding to the terminal device according to the identification information of the terminal device.

3. The method according to claim 2, wherein before storing of the identification information of the terminal device and the number of video layers, the method further comprises:
determining whether there is an update of the number of video layers corresponding to the terminal device;
wherein the storing of the identification information of the terminal device and the number of video layers comprises:
if there is an update of the number of video layers corresponding to the terminal device, storing the identification information of the terminal device and the updated number of video layers.

4. The method according to claim 1, wherein before obtaining of the first video data according to the identification information corresponding to the multiple channels of video data, the method further comprises:
obtaining video data;
generating the picture data according to the video data; and
storing the video data and the picture data.

5. The method according to claim 1, wherein after determining of whether the number of the multiple channels of video data is greater than the number of video layers, the method further comprises:
if the number of the multiple channels of video data is smaller than or equal to the number of video layers, obtaining second video data according to the identification information corresponding to the multiple channels of video data, wherein the second video data is the requested multiple channels of video data;
sending the second video data to the client, so that the client plays the multiple channels of video data simultaneously using the multi-channel player.

6. An electronic device, comprising:
at least one processor; and
a memory communicably connected with the at least one processor for storing instructions executable by the at least one processor, wherein execution of the instructions by the at least one processor causes the at least one processor to:
obtain a play request for playing multiple channels of video data from a client, wherein identification information of a terminal device and identification information corresponding to the multiple channels of video data are carried in the play request;
according to the identification information of the terminal device, determine the number of video layers corresponding to the terminal device;
determine whether the number of the multiple channels of video data is greater than the number of video layers;
if the number of the multiple channels of video data is greater than the number of video layers, obtain first video data according to the identification information corresponding to the multiple channels of video data, wherein the first video data comprises the same number of channels of video data as the number of video layers, and picture data corresponding to remaining channels of video data, and the picture data is picture representation of corresponding video data; and
send the first video data to the client, so that the client plays the channels of video data and the picture data corresponding to remaining channels of video data simultaneously using a multi-channel player.

7. The electronic device according to claim 6, wherein before determining of the number of video layers corresponding to the terminal device according to the identification information of the terminal device, the instructions are executed to cause the at least one processor to:
obtain the identification information of the terminal device and the number of video layers corresponding to the terminal device; and
store the identification information of the terminal device and the number of video layers;
wherein the determining of the number of video layers corresponding to the terminal device according to the identification information of the terminal device comprises:
inquiring the number of video layers corresponding to the terminal device according to the identification information of the terminal device.

8. The electronic device according to claim 7, wherein before storing of the identification information of the terminal device and the number of video layers, the instructions are executed to cause the at least one processor to:
determine whether there is an update of the number of video layers corresponding to the terminal device;
wherein the storing of the identification information of the terminal device and the number of video layers comprises:
if there is an update of the number of video layers corresponding to the terminal device, storing the identification information of the terminal device and the updated number of video layers.

9. The electronic device according to claim 6, wherein before obtaining of the first video data according to the identification information corresponding to the multiple channels of video data, the instructions are executed to cause the at least one processor to:
obtain video data;
generate the picture data according to the video data; and
store the video data and the picture data.

10. The electronic device according to claim 6, wherein after determining of whether the number of the multiple channels of video data is greater than the number of video layers, the instructions are executed to cause the at least one processor to:
if the number of the multiple channels of video data is smaller than or equal to the number of video layers, obtain second video data according to the identification information corresponding to the multiple channels of video data, wherein the second video data is the requested multiple channels of video data; and
send the second video data to the client, so that the client plays the multiple channels of video data simultaneously using the multi-channel player.

11. An electronic device, comprising:
at least one processor; and
a memory communicably connected with the at least one processor for storing instructions executable by the at least one processor, wherein execution of the instructions by the at least one processor causes the at least one processor to:
send a play request for playing multiple channels of video data to a server, wherein identification information of a terminal device and identification information corresponding to the multiple channels of video data are carried in the play request;
receive first video data sent from the server, wherein the first video data comprises the same number of channels of video data as the number of video layers corresponding to the terminal device, and picture data corresponding to remaining channels of video data, wherein the number of video layers corresponding to the terminal device is determined according to the identification information of the terminal device, the picture data is picture representation of corresponding video data, and the first video data is sent from the server when the number of the multiple channels of video data is greater than the number of video layers; and
play the video data and the picture data simultaneously using a multi-channel player.

12. The electronic device according to claim 11, wherein after sending of the play request for playing multiple channels of video data to the server, the instructions are executed to cause the at least one processor to:
receive second video data sent from the server, wherein the second video data is the requested multiple channels of video data, and the second video data is sent from the server when the number of the multiple channels of video data is smaller than or equal to the number of video layers;
wherein the playing of the video data and the picture data simultaneously using a multi-channel player comprises:
playing the multiple channels of video data simultaneously using the multi-channel player.

13. The electronic device according to claim 11, wherein the playing of the video data and the picture data simultaneously using the multi-channel player comprises:
playing the video data and the picture data on different portions of the same screen.
